(19) United States
(12) Patent Application Publication
(10) Pub. No.: US 2009/0159758 A1
(43) Pub. Date: Jun. 25, 2009

(54) MOUNTING STRUCTURE OF EXHAUST PIPE SYSTEM IN VEHICLE

(75) Inventors: Hisashi Nishino, Aichi (JP); Tomoki Mabuchi, Aichi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi, Aichi (JP)

(21) Appl. No.: 11/915,692

(22) PCT Filed: Apr. 28, 2006
(86) PCT No.: PCT/JP2006/309359

§ 371 Date: Mar. 7, 2008

(30) Foreign Application Priority Data
May 27, 2005 (JP) 2005-155987

(51) Int. Cl. F16L 3/08

(52) U.S. Cl. 248/65

(57) ABSTRACT

An exhaust system disposition structure for disposing an exhaust system which includes a tailpipe and a coupling member that couples the exhaust system to an exhaust manifold, with the exhaust system being disposed on a vehicle body from the coupling member to an end of the tailpipe is provided. The structure includes a support member that supports, on the vehicle body, the exhaust system from the coupling member to the tailpipe end, at one position further toward the tailpipe end than a center of gravity of the exhaust system and at, or in the vicinity of, a principal axis of inertia of the exhaust system. Thus, the position of the entire exhaust system can be easily adjusted in comparison to a configuration where the exhaust system is supported by plural support members.

### BACKGROUND OF THE INVENTION

1. Field of the Invention

The present invention relates to an exhaust system disposition structure, and more particularly to an exhaust system disposition structure where an exhaust system from a coupling member that couples the exhaust system to an exhaust manifold until a tailpipe end is disposed on a vehicle body.

2. Description of the Related Art

In a vehicle disposed with an internal combustion engine, an exhaust system for discharging exhaust gas to the atmosphere is disposed. The exhaust system is supported on the vehicle body by plural support members (e.g., see Japanese Patent Application Publication (JP-A) No. 2002-160536). For example, in the example described in JP-A No. 2002-160536, a catalyst support member, a muffler support member, a front side pipe support member and a rear side pipe support member are disposed in the exhaust system, and the exhaust system is supported on the vehicle body by these plural support members.

However, in the example described in JP-A No. 2002-160536, the exhaust system is supported on the vehicle body by the plural support members. For this reason, when the position of the entire exhaust system is adjusted (aligned), it has been necessary to adjust the position of each of the plural support members. For this reason, adjusting the position of the entire exhaust system has been complicated.

In order to facilitate adjusting the position of the entire exhaust system, it is also conceivable to reduce the number of support members for supporting the exhaust system on the vehicle body.

Yet when the number of support members is reduced in a conventional exhaust system, there is the potential for the load acting on each support member to increase, or for the load acting on the coupling member that couples together the exhaust manifold and the exhaust pipe, the load acting on the muffler member, and the load acting on the catalyst member to locally increase.

Consequently, in the technical field of disposing exhaust systems on vehicle bodies, it has been a challenge to reduce the number of support members to facilitate adjusting the position of the entire exhaust system without applying a special design for raising strength to the constituent elements of the exhaust system, such as the support members, the coupling member that couples together the exhaust manifold and the exhaust pipe, the muffler member, and the catalyst member.

### SUMMARY OF THE INVENTION

The present invention has been made in view of this circumstance and provides an exhaust system disposition structure where the position of the entire exhaust system can be easily adjusted in comparison to a configuration where the exhaust system is supported on the vehicle body by plural support members as has conventionally been the case.

The present invention also provides an exhaust system disposition structure that can render unnecessary applying a special design for raising strength to the constituent elements of an exhaust system beginning with the support members, even when the number of support members is reduced to facilitate adjusting the position of the entire exhaust system.

A first aspect of the invention provides an exhaust system disposition structure for disposing an exhaust system which includes a tailpipe and a coupling member that couples the exhaust system to an exhaust manifold, with the exhaust system being disposed on a vehicle body from the coupling member to an end of the tailpipe, the structure including: a support member that supports, on the vehicle body, the exhaust system from the coupling member to the tailpipe end, at one position further toward the tailpipe end than a center of gravity of the exhaust system and at, or in the vicinity of, a principal axis of inertia of the exhaust system.

In the present invention, the principal axis of inertia is a hypothetical axis that extends along the longitudinal direction of the exhaust system when the exhaust system disposition structure is seen in plan view, and refers to an axis of torsional vibration in the exhaust system in which there is little torsional vibration displacement.

In the exhaust system disposition structure of the first aspect, the exhaust system from the coupling member to the tailpipe end is supported at one position (place) on the vehicle body.

Consequently, the position of the entire exhaust system can be adjusted (aligned) at the one place of the support member that supports the exhaust system on the vehicle body. Thus, the position of the entire exhaust system can be easily adjusted in comparison to a configuration where the exhaust system is supported on the vehicle body by plural support members as has conventionally been the case.

Further, in the exhaust system disposition structure, the support member that supports the exhaust system on the vehicle body is positioned at, or in the vicinity of, the axis of inertia of the exhaust system further toward the tailpipe end than the center of gravity of the exhaust system.

Consequently, even if torsional vibration centered on the principal axis of inertia arises in the entire exhaust system due to the running (traveling) of the vehicle or the like, there is little torsional vibration displacement (movement in the left-right direction) on the principal axis of inertia on which the support member is positioned. For this reason, the torsional moment acting on the support member can be kept low.

Thus, because the load acting on the support member is reduced, it is not necessary to apply a special design for raising strength to the support member even when the exhaust system from the coupling member to the tailpipe end is supported on the vehicle body by the one support member.

A second aspect of the invention provides an exhaust system disposition structure for disposing an exhaust system which includes a tailpipe and a coupling member that couples the exhaust system to an exhaust manifold, with the exhaust system being disposed on a vehicle body from the coupling member to an end of the tailpipe, the structure including: a support member that supports, on the vehicle body, the exhaust system from the coupling member to the tailpipe end at one position further toward the tailpipe end than a center of gravity of the exhaust system, wherein the center of gravity of the exhaust system is disposed at, or in the vicinity of, a straight line joining in plan view the coupling member and the support member.

In the exhaust system disposition structure of the second aspect, the exhaust system from the coupling member to the tailpipe end is supported at one position (place) on the vehicle body.

Consequently, the position of the entire exhaust system can be adjusted (aligned) at the one place of the support member that supports the exhaust system on the vehicle body. Thus, the position of the entire exhaust system can be easily adjusted in comparison to a configuration where the exhaust system is supported on the vehicle body by plural support members as has conventionally been the case.

Further, in the above exhaust system disposition structure, the center of gravity of the exhaust system is positioned at, or in the vicinity of, the straight line joining in plan view the coupling member and the support member that supports the exhaust system on the vehicle body.

Consequently, even if torsional vibration centered on the straight line joining the support member and the coupling member arises in the entire exhaust system due to the running of the vehicle or the like, there is little torsional vibration displacement (movement in the left-right direction) at, or in the vicinity of, the straight line on which the support member is positioned. For this reason, the torsional moment acting on the support member can be kept low.

Thus, because the load acting on the support member is reduced, it is not necessary to apply a special design for raising strength to the support member even when the exhaust system from the coupling member to the tailpipe end is supported on the vehicle body by the one support member.

Moreover, in the above exhaust system disposition structure, the position of the center of gravity of the exhaust system is maintained at, or in the vicinity of, the straight line joining in plan view the support member and the coupling member, even when the position of the support member is moved to adjust the position of the entire exhaust system.

Consequently, the torsional moment in the left-right direction acting on the support member does not become biased even when the position of the entire exhaust system is adjusted. For this reason, it is not necessary to carry out reinforcement corresponding to bias of the torsional moment in the left-right direction acting on the support member each time the position of the exhaust system is adjusted.

In the exhaust system disposition structure, the center of gravity of the exhaust system may be disposed at a position substantially one half of the length of the exhaust system in a vehicle front-rear direction.

According to this configuration, the load acting on the coupling member that couples the exhaust system to the exhaust manifold and the load acting on the support member that supports the exhaust system on the vehicle body can be substantially equalized, and the front-rear balance of the weight of the exhaust system becomes excellent.

Further, even if torsional vibration centered on the principal axis of inertia or if torsional vibration centered on the straight line joining in plan view the support member and the coupling member arises in the entire exhaust system due to the running of the vehicle or the like, the portion of the exhaust system from the center of gravity to the coupling member and the portion of the exhaust system from the center of gravity to the support member vibrate in directions that mutually cancel out the torsional vibration, with the principal axis of inertia or the straight line joining in plan view the support member and the coupling member serving as the vibration axis.

Consequently, the torsional moment (resulting from the mass and torsional vibration of the exhaust system) acting on the portion of the exhaust system from the center of gravity to the coupling member and the torsional moment acting on the portion of the exhaust system from the center of gravity to the support member act in directions that mutually cancel them out, and the torsional moments of both become nearly equal. For this reason, the torsional moments acting on the support member and the coupling member can be prevented from becoming biased.

Thus, it becomes unnecessary to apply a special design for raising the strength of the support member and the coupling member corresponding to bias in the torsional moments.

In the exhaust system disposition structure, the exhaust system may further include a muffler disposed such that the position of a vehicle front side portion of the muffler is at a position substantially one half of the length of the exhaust system in the vehicle front-rear direction.

When the muffler, which is usually a heavy load in the exhaust system, is disposed such that the position of the vehicle front side portion of the muffler is at a position substantially one half of the length of the exhaust system in a vehicle front-rear direction in this manner, it becomes easy to set the center of gravity of the exhaust system to a position substantially one half of the length of the exhaust system in the vehicle front-rear direction because of the weight balance with the catalyst disposed further toward the coupling member than the muffler.

Additionally, when the center of gravity of the exhaust system is set at a position substantially one half of the length of the exhaust system in the vehicle front-rear direction, the load acting on the coupling member that couples the exhaust system to the exhaust manifold and the load acting the support member can be substantially equalized, and the front-rear balance of the weight of the exhaust system becomes excellent.

Moreover, even if torsional vibration centered on the principal axis of inertia or if torsional vibration centered on the straight line joining in plan view the support member and the coupling member arises in the entire exhaust system due to the running of the vehicle or the like, the portion of the exhaust system from the center of gravity to the coupling member and the portion of the exhaust system from the center of gravity to the support member vibrate in directions that mutually cancel out the torsional vibration, with the principal axis of inertia or the straight line joining in plan view the support member and the coupling member serving as the vibration axis.

Consequently, the torsional moment (resulting from the mass and torsional vibration of the exhaust system) acting on the portion of the exhaust system from the center of gravity to the coupling member and the torsional moment acting on the portion of the exhaust system from the center of gravity to the support member act in directions that mutually cancel them out. Further, because the torsional moments of both become nearly equal, the torsional moments acting on the support member and the coupling member can be prevented from becoming biased.

Thus, it becomes unnecessary to apply a special design for raising the strength of the support member and the coupling member corresponding to bias in the torsional moments.

Moreover, when the muffler is disposed such that the position of a vehicle front side portion of the muffler is at a position substantially one half of the length of the exhaust system in the vehicle front-rear direction, the center of gravity of the exhaust system is disposed in the vicinity of the vehicle front side portion of the muffler due to the weight balance with the catalyst disposed further toward the coupling member than the muffler.

Consequently, the torsional moment acting on the joint portion between the vehicle front side portion of the muffler and the exhaust pipe can be reduced in comparison to a configuration where the center of gravity of the exhaust system is disposed at a position far from the vehicle front side portion of the muffler.

Thus, it becomes unnecessary to apply a special design for raising strength to the joint portion between the vehicle front side portion of the muffler and the exhaust pipe.

In the exhaust system disposition structure, the exhaust system may further include a muffler and a catalyst, and the catalyst may be disposed at a position substantially one half of the length in the vehicle front-rear direction between the coupling member and the vehicle front side portion of the muffler, or substantially one half of the length in the vehicle front-rear direction between the coupling member and the center of gravity of the exhaust system.

When the catalyst is disposed at a position substantially one half of the length in the vehicle front-rear direction between the coupling member and the vehicle front side portion of the exhaust system in this manner, it becomes easy to set the center of gravity of the portion of the exhaust system positioned further frontward than the vehicle front side portion of the muffler at a substantially intermediate position between the vehicle front side of the muffler and the coupling member that couples the exhaust system to the exhaust manifold.

Additionally, when the center of gravity of the portion of the exhaust system positioned further frontward than the vehicle front side portion of the muffler is set at a substantially intermediate position between the vehicle front side portion of the muffler and the coupling member, the balance of the centers of gravity at both sides of the catalyst (the portion between the catalyst and the coupling member, and the portion between the catalyst and the vehicle front side portion of the muffler) can be substantially equalized at the portion of the exhaust system positioned further frontward than the vehicle front side portion of the muffler.

Further, even if flexural vibration centered on the coupling member and the vehicle front side portion of the muffler arises in the portion of the exhaust system further frontward than the vehicle front side portion of the muffler, the catalyst becomes positioned in the loop (antinode) of the vibration (i.e., the entire catalyst moves) as a result of the catalyst being disposed at the position one half of the length in the vehicle front-rear direction between the coupling member and the vehicle front side portion of the muffler.

Thus, the torsional moment acting on one of connecting members that connect the catalyst to a pair of exhaust pipes disposed on both ends of the catalyst can be prevented from becoming biased.

Consequently, because it suffices for the same strength measure to be carried out with respect to both of the connecting members that connect the catalyst to the pair of exhaust pipes disposed on both ends of the catalyst, it is not necessary to apply a special design such as carrying out individual strength measures with respect to both of the connecting members between the exhaust pipes and the catalyst.

When the center of gravity of the exhaust system is disposed in the vicinity of the vehicle front side portion of the muffler, the catalyst may be disposed at a position substantially one half of the length in the vehicle front-rear direction between the coupling member and the center of gravity of the exhaust system.

Even if the invention is configured in this manner, the same action and effects as when the catalyst is disposed at a position substantially one half of the length in the vehicle front-rear direction between the coupling member and the vehicle front side portion of the muffler can be exhibited.

In the exhaust system disposition structure, the exhaust system may further include a vibration isolating mechanism disposed further toward the tailpipe end than the coupling member, and the muffler and the support member may be disposed further toward the tailpipe end than the vibration isolating mechanism.

As a result of this structure, the center of gravity of the exhaust system can be moved by moving the support member around the vibration isolating mechanism. Therefore, it becomes more easier to adjust the position of the entire exhaust system.

In the exhaust system disposition structure, vibration isolating mechanisms may be disposed at the coupling member and at a position rearward of the catalyst of the exhaust system.

Because the vibration isolating mechanisms are disposed at the coupling member and at a position rearward of the catalyst, the joint portions of the exhaust system can be reduced to at least two places. Thus, it becomes even easier to adjust the position of the entire exhaust system.

As described in detail above, in the exhaust system disposition structure according to the first and second aspects, the position of the entire exhaust system can be adjusted (aligned) at the one place of the support member that supports the exhaust system on the vehicle body. Thus, the position of the entire exhaust system can be easily adjusted in comparison to a configuration where the exhaust system is supported on the vehicle body by plural support members as has conventionally been the case.

Further, because the load acting on the support member is reduced, it is not necessary to apply a special design for raising strength to the support member even when the exhaust system from the coupling member to the tailpipe end is supported on the vehicle body by the one support member.

### BRIEF DESCRIPTION OF THE DRAWINGS

FIG. 1 is a plan view showing an exhaust system disposition structure pertaining to a first embodiment of the invention.

FIG. 2 is a plan view showing an exhaust system disposition structure pertaining to a second embodiment of the invention.

FIG. 3 is a plan view showing an exhaust system disposition structure pertaining to a third embodiment of the invention.

### DESCRIPTION OF THE PREFERRED EMBODIMENT

Embodiments of the invention will be described below with reference to the drawings. It will be noted that the members and dispositions described below should not be construed as limiting the invention and can of course be variously modified in adherence to the gist of the invention.

### First Embodiment

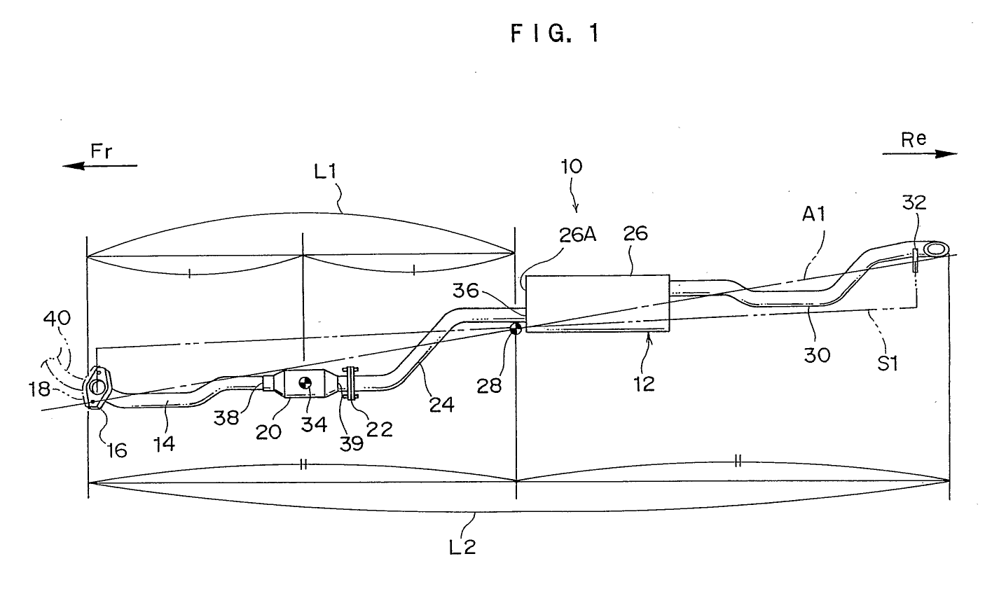

To begin, the configuration of an exhaust system disposition structure pertaining to a first embodiment of the invention will be described with reference to FIG. 1.

An exhaust system disposition structure 10 pertaining to the first embodiment of the invention is applied to a vehicle such as a passenger automobile disposed with an internal combustion engine, for example. An exhaust system 12 for discharging to the atmosphere exhaust gas discharged from the internal combustion engine is disposed in the exhaust system disposition structure 10 pertaining to the first embodiment of the invention.

A first exhaust pipe 14 is disposed frontward (Fr side) of the exhaust system 12, and a flange-like coupling member 16 is disposed frontward (Fr side) of the first exhaust pipe 14. The coupling member 16 is connected to an exhaust manifold 40 via a first vibration isolating mechanism 18.

The first vibration isolating mechanism 18 isolates (absorbs) flexural vibration arising between the exhaust manifold 40 and the first exhaust pipe 14, and is configured by a ball joint or the like, for example.

A catalyst 20 is disposed rearward (Re side) of the first exhaust pipe 14. The catalyst 20 is disposed such that its center of gravity 34 is positioned at a position one half of a length L1 in the vehicle front-rear direction between a center of gravity 28 of the exhaust system 12 and the coupling member 16.

A second exhaust pipe 24 is disposed rearward (Re side) of the catalyst 20 via a second vibration isolating mechanism 22. The second vibration isolating mechanism 22 isolates (absorbs) flexural vibration arising between the first exhaust pipe 14 and the second exhaust pipe 24, and is configured by a ball joint or the like, for example.

A muffler 26 is disposed rearward (Re side) of the second exhaust pipe 24. In the present embodiment, the center of gravity 28 of the exhaust system 12 is set at a position one half of a length L2 of the exhaust system 12 in the vehicle front-rear direction, and a vehicle front side portion 26A of the muffler 26 is positioned in the vicinity of the center of gravity 28.

Further, the balance of the weight of the entire exhaust system 12 is set such that the center of gravity 28 of the exhaust system 12 is positioned on a principal axis of inertia A1 of the exhaust system 12.

In the first embodiment of the invention, the principal axis of inertia A1 is a hypothetical axis that extends along the longitudinal direction of the exhaust system 12 when the exhaust system disposition structure 10 is seen in plan view, and refers to an axis of torsional vibration in the exhaust system 12 in which there is little torsional vibration displacement.

A tailpipe 30 is disposed rearward (Re side) of the muffler 26. A support member 32 is disposed on the tailpipe 30 such that the support member 20 is positioned on the principal axis of inertia A1 of the exhaust system 12.

Additionally, in the first embodiment of the invention, the entire exhaust system 12 from the coupling member 16 to the tailpipe 30 end is supported on an unillustrated vehicle body by the support member 32. In other words, in the first embodiment of the invention, the entire exhaust system 12 from the coupling member 16 to the tailpipe 30 end is supported on the vehicle body at only one place at the principal axis of inertia A1 of the exhaust system 12.

The support member used in the present invention may be, for example, an arm-like member or the like. However, the embodiment of the support member is not limited to this. Any other member, means, or method for supporting, which enables to support the entire exhaust system in above-described manner can be used.

Next, the action of the exhaust system disposition structure pertaining to the first embodiment of the invention will be described.

According to the exhaust system disposition structure 10 pertaining to the first embodiment of the invention, the exhaust system 12 from the coupling member 16 to the tailpipe 30 end is supported on the unillustrated vehicle body at only the one place of the support member 32. For this reason, the position of the entire exhaust system 12 can be adjusted (aligned) at the one place of the support member 32.

Thus, the position of the entire exhaust system 12 can be easily adjusted in comparison to a configuration where the exhaust system is supported on the vehicle body by plural support members as has conventionally been the case.

Further, because there is only one support member 32 that supports the exhaust system 12 on the vehicle body, the number of points where vibration is transmitted from the vehicle body to the exhaust system 12 can also be reduced in comparison to what has conventionally been the case. Thus, the vibrational noise performance of the exhaust system 12 can also be made excellent.

Moreover, because it becomes easy to adjust the position of the entire exhaust system 12 as a result of the exhaust system 12 being supported on the vehicle body at only the one place of the support member 32 as mentioned above, highly precise positional adjustment can be conducted even if one is not a skilled worker.

Further, because the torsional moment acting on the support member 32 accompanying positional shifting of the exhaust system 12 can be reduced when the precision of the disposed position of the exhaust system 12 becomes higher in this manner, the vibrational noise performance of the exhaust system 12 can be made excellent as a result.

Further, in the exhaust system disposition structure 10, the support member 32 supporting the exhaust system 12 on the vehicle body is positioned on the principal axis of inertia A1 of the exhaust system 12.

Consequently, even if torsional vibration centered on the principal axis of inertia A1 arises in the entire exhaust system 12 due to the running of the vehicle or the like, there is little torsional vibration displacement (movement in the left-right direction) on the principal axis of inertia A1 on which the support member 32 is positioned. For this reason, the torsional moment acting on the support member 32 can be kept low.

Thus, because the load acting on the support member 32 is reduced, it is not necessary to apply a special design for raising strength to the support member 32 even when the exhaust system 12 from the coupling member 16 to the tailpipe 30 end is supported on the vehicle body by the one support member 32.

Further, in the exhaust system disposition structure 10, the center of gravity 28 of the exhaust system 12 is disposed at the position one half of the length L2 of the exhaust system 12 in the vehicle front-rear direction.

In this case, when the center of gravity 28 of the exhaust system 12 is further frontward than the position one half of the length L2 of the exhaust system 12 in the vehicle front-rear direction, the load and the torsional moment acting on the support member 32 increase. And when the center of gravity 28 of the exhaust system 12 is further rearward than the position one half of the length L2 of the exhaust system 12 in the vehicle front-rear direction, the load and the torsional moment acting on the coupling member 16 increase.

Yet in the first embodiment of the invention, as mentioned above, the center of gravity 28 of the exhaust system 12 is disposed at one half of the length L2 of the exhaust system 12 in the vehicle front-rear direction. For this reason, the load acting on the coupling member 16 and the load acting on the support member 32 can be substantially equalized, and the front-rear balance of the weight of the exhaust system 12 becomes excellent.

Further, even if torsional vibration centered on the principal axis of inertia A1 arises in the entire exhaust system 12 due to the running of the vehicle or the like, the portion of the exhaust system 12 from the center of gravity 28 to the coupling member 16 and the portion of the exhaust system 12 from the center of gravity 28 to the support member 32 vibrate in directions that mutually cancel out the torsional vibration, with the principal axis of inertia A1 serving as the vibration axis.

Consequently, the torsional moment (resulting from the mass and torsional vibration of the exhaust system) acting on the portion of the exhaust system 12 from the center of gravity 28 to the coupling member 16 and the torsional moment acting on the portion of the exhaust system 12 from the center of gravity 28 to the support member 32 act in directions that mutually cancel them out. (The amplitude of the torsional vibrations of both is indicated in FIG. 1 by the two-dotted chain line S1.) Because the torsional moments of both become nearly equal, the torsional moments acting on the support member 32 and the coupling member 16 can be prevented from becoming biased.

Thus, it becomes unnecessary to apply a special design for raising the strength of the support member 32 and the coupling member 16 corresponding to bias in the torsional moments.

Further, torsional vibration whose node (a point where there is little displacement) is the center of gravity 28 of the exhaust system 12 occurs in the exhaust system 12. For this reason, by disposing the center of gravity 28 at one half of the length L2 of the exhaust system 12 in the vehicle front-rear direction, as in the present embodiment, it becomes easy to dispose the constituent elements of the exhaust system 12 in order to cancel out torsional vibration at areas frontward and rearward of the center of gravity 28.

Moreover, in the present embodiment, the muffler 26 is disposed such that the vehicle front side portion 26A of the muffler 26 is positioned in the vicinity of the position one half of the length L2 of the exhaust system in the vehicle front-rear direction.

In this case, when the center of gravity 28 of the exhaust system 12 is disposed at a position away from the vehicle front side portion 26A of the muffler 26, the load and torsional moment acting on a joint member 36 where the muffler 26 and the second exhaust pipe 24 increase.

Yet when the center of gravity 28 of the exhaust system 12 is disposed in the vicinity of the vehicle front side portion 26A of the muffler 26, as in the first embodiment of the invention, the load and torsional moment acting on the joint member 36 can be reduced in comparison to a configuration where the center of gravity 28 of the exhaust system 12 is disposed at a position far from the vehicle front side portion 26A of the muffler 26.

Thus, it becomes unnecessary to apply a special design for raising strength to the joint member 36 that joins the muffler 26 to the second exhaust pipe 24.

Incidentally, the exhaust system 12 vibrates in modes that differ depending on the frequency region. Consequently, in order to suppress unpleasant vibration such as when the engine is idling, it is necessary to use a dynamic damper in the exhaust system 12.

In this case, an ordinary dynamic damper is generally disposed at a pinpoint position (an area where vibration is large in a frequency band in which the vibration is intended to be reduced) in the exhaust system 12 and for its mass to be matched to the frequency band in which the vibration is intended to be reduced.

Further, if the vibrational frequency of the exhaust system 12 differs in response to the vehicle environment, areas where vibration is large in the exhaust system 12 occur at different plural positions in the longitudinal direction of the exhaust system 12 per vibrational frequency. Consequently, in this case it is necessary to dispose dynamic dampers at different plural positions in the longitudinal direction of the exhaust system 12 in order to suppress vibration of the exhaust system 12.

Yet in the present embodiment, the muffler 26 is disposed rearward (Re side) of the center of gravity 28 of the exhaust system 12 as mentioned above. Thus, the present embodiment is configured to exhibit the same action as when plural dynamic dampers are disposed in the exhaust system 12 as has conventionally been the case.

In other words, because the muffler 26 is long in the longitudinal direction of the exhaust system 12, is rigid, and is difficult to break in the vertical direction, a vibration reducing effect is obtained in a wider frequency band (e.g., idling vibrational frequency band of 30 to 100 Hz) in comparison to dynamic dampers disposed at conventional pinpoints as described above.

Further, because the muffler 26 is long in the longitudinal direction of the exhaust system 12, a vibration reducing effect is obtained in a range that is wide in the longitudinal direction of the exhaust system 12 in comparison to dynamic dampers disposed at conventional pinpoints.

In this manner, according to the present embodiment, it is not necessary to use dynamic dampers in the exhaust system 12 because the muffler 26 is disposed with a vibration reducing effect.

Further, when the catalyst 20 is disposed such that its center of gravity is positioned at a position one half of the length L1 in the vehicle front-rear direction between the coupling member 16 and the center of gravity 28 of the exhaust system 12, it becomes easy to set the center of gravity 34 of the portion of the exhaust system 12 positioned further frontward than the vehicle front side portion 26A of the muffler 26 at a substantially intermediate position between the center of gravity 28 of the exhaust system 12 and the coupling member 16.

When the center of gravity 34 is set at a substantially intermediate position between the center of gravity 28 of the exhaust system 12 and the coupling member 16, as well as the vehicle front side portion 26A of the muffler 26 is positioned in the vicinity of the center of gravity 28 in the present embodiment, the balance of the centers of gravity at both sides of the catalyst 20 can be substantially equalized at the portion of the exhaust system 12 positioned further frontward than the vehicle front side portion 26A of the muffler 26.

Further, even if flexural vibration centered on the coupling member 16 and the vehicle front side portion 26A of the muffler 26 arises in the portion of the exhaust system 12 positioned further frontward than the vehicle front side portion 26A of the muffler 26, the catalyst 20 becomes positioned in the center (loop) of the vibration (i.e., the entire catalyst 20 moves) as a result of the catalyst 20 being disposed at the position one half of the length L1 in the vehicle front-rear direction between the coupling member 16 and the vehicle front side portion 26A of the muffler 26.

Thus, it can be ensured that the moment acting on one of welded connecting members 38 and 39 that connect the catalyst 20 to the first exhaust pipe 14 and the second exhaust pipe 24 disposed on both ends of the catalyst 20 does not become biased.

Consequently, it suffices for the same strength measure to be carried out with respect to both of the welded connecting members 38 and 39 of the catalyst 20, and it is not necessary to apply a special design such as carrying out individual strength measures (e.g., setting the plate thicknesses, setting the range of the welded members, etc.) with respect to both of the welded connecting members 38 and 39.

Further, in the exhaust system disposition structure 10, the second vibration isolating mechanism 22 is disposed further toward the tailpipe 30 than the coupling member 16, and the muffler 26 and the support member 32 are disposed further toward the tailpipe 30 than the second vibration isolating mechanism 22.

Thus, the position of the center of gravity 28 of the exhaust system 12 can be moved by moving the support member 32 around the second vibration isolating mechanism 22. For this reason, the position of the entire exhaust system 12 can be more easily adjusted.

In particular, in the exhaust system disposition structure 10, in addition to the second vibration isolating mechanism 22 being disposed rearward (Re side) of the catalyst 20, the first vibration isolating mechanism 18 is disposed between the coupling member 16 and the exhaust manifold 40.

In this manner, in the present embodiment, there are two joint portions in the exhaust system 12 as a result of disposing the first vibration isolating mechanism 18 and the second vibration isolating mechanism 22 in the exhaust system 22. Thus, it becomes even easier to adjust the position of the entire exhaust system 12.

As described in detail above, according to the exhaust system disposition structure 10 pertaining to the first embodiment of the invention, the position of the entire exhaust system 12 can be adjusted (aligned) at the one place of the support member 32 that supports the exhaust system 12 on the vehicle body. For this reason, the position of the entire exhaust system 12 can be easily adjusted in comparison to a configuration where the exhaust system is supported on the vehicle body by plural support members as has conventionally been the case.

Further, even when adjusting the position of the entire exhaust system 12 is facilitated in this manner, it is not necessary to apply a special design for raising strength to the constituent elements of the exhaust system 12 by altering the configuration/disposition of the constituent elements of the exhaust system 12 like the support member 32, the coupling member 16, the muffler 26 and the catalyst 20, as described in detail above.

Next, modifications of the exhaust system disposition structure pertaining to the first embodiment of the invention will be described.

In the first embodiment of the invention, the exhaust system 12 is supported on the vehicle body at one place on the principal axis of inertia A1. However, the exhaust system 12 may also be supported on the vehicle body at one place in the vicinity of the principal axis of inertia A1.

Further, in the present embodiment, the center of gravity 28 of the exhaust system 12 is disposed on the principal axis of inertia A1 of the exhaust system 12. However, the balance of the weight of the entire exhaust system 12 may also be set such that the center of gravity 28 of the exhaust system 12 is disposed in the vicinity of the principal axis of inertia A1 of the exhaust system 12.

Moreover, in the present embodiment, the center of gravity 28 of the exhaust system 12 is disposed at a position one half of the length L2 of the exhaust system 12 in the vehicle front-rear direction. However, the muffler 26 may be also disposed such that the vehicle front side portion 26A of the muffler 26 is at the position one half of the length L2 of the exhaust system 12 in the vehicle front-rear direction, and the center of gravity 28 of the exhaust system 12 may be disposed in the vicinity of the position one half of the length L2 of the exhaust system 12 in the vehicle front-rear direction.

Even if the invention is configured in this manner, it becomes unnecessary to apply a special design for raising the strength of the support member 32 and the coupling member 16 because the loads acting on the support member 32 and the coupling member 16 are reduced.

Further, in the first embodiment of the invention, the catalyst 20 is disposed such that its center of gravity is positioned at a position substantially one half of the length L1 in the vehicle front-rear direction between the center of gravity 28 of the exhaust system 12 and the coupling member 16. However, the catalyst 20 may also be disposed such that its center of gravity is positioned at a position one half of the length L1 in the vehicle front-rear direction between the vehicle front side portion 26A of the muffler 26 and the coupling member 16.

Even if the invention is configured in this manner, it can be ensured that the moment acting on one of the welded connecting members 38 and 39 that connect the catalyst 20 to the first exhaust pipe 14 and the second exhaust pipe 24 disposed on both ends of the catalyst 20 does not become biased.

### Second Embodiment

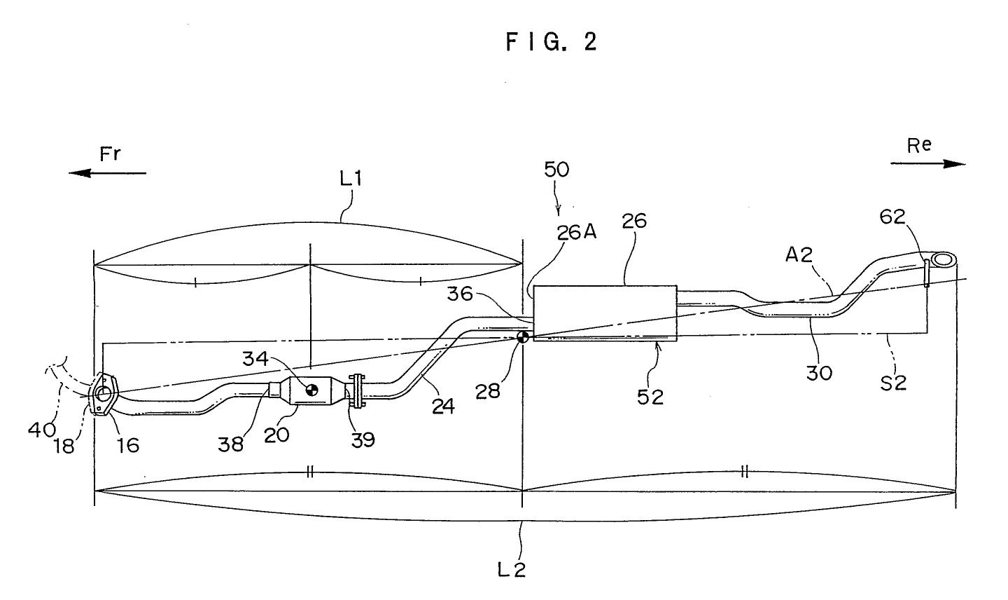

Next, the configuration of an exhaust system disposition structure pertaining to a second embodiment of the invention will be described with reference to FIG. 2.

In an exhaust system disposition structure 50 pertaining to the second embodiment of the invention, a hanger-like support member 62 is disposed on the tailpipe 30. Additionally, in the exhaust system disposition structure 50 pertaining to the second embodiment of the invention, an exhaust system 52 from the coupling member 16 to the tailpipe 30 end is supported at only one place on an unillustrated vehicle body by the support member 62.

Further, in the exhaust system disposition structure 50, the position of the support member 62 is set such that the center of gravity 28 of the exhaust system 52 is disposed on a straight line A2 joining in plan view the coupling member 16 and the support member 62 that supports the exhaust system 52 on the vehicle body.

In the present embodiment, the straight line A2 is the principal axis of inertia of the exhaust system 52. Here, the principal axis of inertia is a hypothetical axis that extends along the longitudinal direction of the exhaust system 52 when the exhaust system disposition structure 50 is seen in plan view, and refers to an axis in which there is little torsional vibration displacement as an axis of torsional vibration in the exhaust system 52.

Additionally, the center of gravity 28 of the exhaust system 52 is set at a position one half of the length L2 of the exhaust system 52 in the vehicle front-rear direction. Thus, in the present embodiment, the disposed position of the coupling member 16 and the disposed position of the support member 62 are symmetrical around the center of gravity 28 with respect to the center of gravity 28 of the exhaust system 52.

Further, in the exhaust system disposition structure 50, the support member 62 is positioned further upward in the vertical direction than the coupling member 16 when the exhaust system disposition structure 50 is seen in side view. For this reason, the exhaust system 52 toward the tailpipe 30 end is hoisted up.

In the exhaust system disposition structure 50, the configuration other than the configuration where the exhaust system 52 is supported on the vehicle body at only one place on the straight line L2 is the same as that of the exhaust system disposition structure 10 pertaining to the first embodiment, so description thereof will be omitted.

Further, in the exhaust system disposition structure 50 pertaining to the second embodiment of the invention shown in FIG. 2, the same reference numerals are used for members that are the same as those in the exhaust system disposition structure 10 pertaining to the first embodiment.

Next, the action of the exhaust system disposition structure pertaining to the second embodiment of the invention will be described.

According to the exhaust system disposition structure 50 pertaining to the second embodiment of the invention, the position of the entire exhaust system 52 can be adjusted (aligned) at the one place of the support member 62 because the exhaust system 52 from the coupling member 16 to the tailpipe 30 end is supported on the unillustrated vehicle body at only the one place of the support member 62.

Thus, the position of the entire exhaust system 52 can be easily adjusted in comparison to a configuration where the exhaust system is supported on the vehicle body by plural support members as has conventionally been the case.

Further, in the exhaust system disposition structure 50, the center of gravity 28 of the exhaust system 52 is disposed on the straight line A2 joining in plan view the support member 62 and the coupling member 16.

Consequently, even if torsional vibration centered on the straight line A2 joining in plan view the support member 62 and the coupling member 16 arises in the entire exhaust system 52 due to the running of the vehicle or the like, there is little torsional vibration displacement (movement in the left-right direction) on the straight line A2 on which the support member 62 is positioned. For this reason, the torsional moment acting on the support member 62 can be kept low.

Thus, because the load acting on the support member 62 is reduced, it is not necessary to apply a special design for raising strength to the support member 62 even when the exhaust system 52 from the coupling member 16 to the tailpipe 30 end is supported on the vehicle body by the one support member 62.

Moreover, in the exhaust system disposition structure 50, the position of the center of gravity 28 of the exhaust system 52 is maintained on the straight line A2 joining in plan view the support member 62 and the coupling member 16, even if the position of the support member 62 is moved to adjust the position of the entire exhaust system 52.

Consequently, the torsional moment in the left-right direction acting on the support member 62 does not become biased even when the position of the entire exhaust system 52 is adjusted. For this reason, it is not necessary to carry out reinforcement corresponding to bias of the torsional moment in the left-right direction acting on the support member 62 each time the position of the exhaust system 52 is adjusted.

Further, in the second embodiment of the invention, because the center of gravity 28 of the exhaust system 52 is disposed at one half of the length L2 of the exhaust system 52 in the vehicle front-rear direction as mentioned above, the load acting on the coupling member 16 and the load acting on the support member 62 can be substantially equalized, and the front-rear balance of the weight of the exhaust system 52 becomes excellent.

Further, even if torsional vibration centered on the straight line A2 arises in the entire exhaust system due to the running of the vehicle or the like, the disposed position of the coupling member 16 and the disposed position of the support member 62 are symmetrical around the center of gravity 28. For this reason, the portion of the exhaust system 12 from the center of gravity 28 to the coupling member 16 and the portion of the exhaust system 12 from the center of gravity 28 to the support member 62 vibrate in directions that mutually cancel out the torsional vibrations, with the straight line A2 serving as the vibration axis.

Consequently, the torsional moment (resulting from the mass and torsional vibration of the exhaust system) acting on the portion of the exhaust system 52 from the center of gravity 28 to the coupling member 16 and the torsional moment acting on the portion of the exhaust system 52 from the center of gravity 28 to the support member 62 act in directions that mutually cancel out. (The amplitude of the torsional vibrations of both is indicated in FIG. 2 by the two-dotted chain line S2.) Further, because the torsional moments of both become equal, the torsional moments acting on the support member 62 and the coupling member 16 can be prevented from becoming biased.

Thus, it becomes unnecessary to apply a special design for raising the strength of the support member 62 and the coupling member 16 corresponding to bias in the torsional moment.

Further, in the exhaust system disposition structure 50 of the present embodiment, the support member 62 is positioned further upward in the vertical direction than the coupling member 16 when the exhaust system disposition structure 50 is seen in side view. Thus, because the tailpipe 30 end of the exhaust system 52 is hoisted up, the tailpipe 30 end of the exhaust system 52 can be stably fixed to the vehicle body.

Thus, because the load acting on the support member 62 is further reduced, it becomes unnecessary to apply a special design for raising the strength of the support member 62.

It will be noted that the action and effects of the exhaust system disposition structure 50 pertaining to the second embodiment of the invention that result from the same configuration as that of the exhaust system disposition structure 10 pertaining to the first embodiment may be understood by referring to the first embodiment, and description thereof will be omitted here.

Next, a modification of the exhaust system disposition structure pertaining to the second embodiment of the invention will be described.

In the second embodiment of the invention, the center of gravity 28 of the exhaust system 52 is disposed on the straight line A2. However, the center of gravity 28 of the exhaust system 52 may also be disposed in the vicinity of the straight line A2.

### Third Embodiment

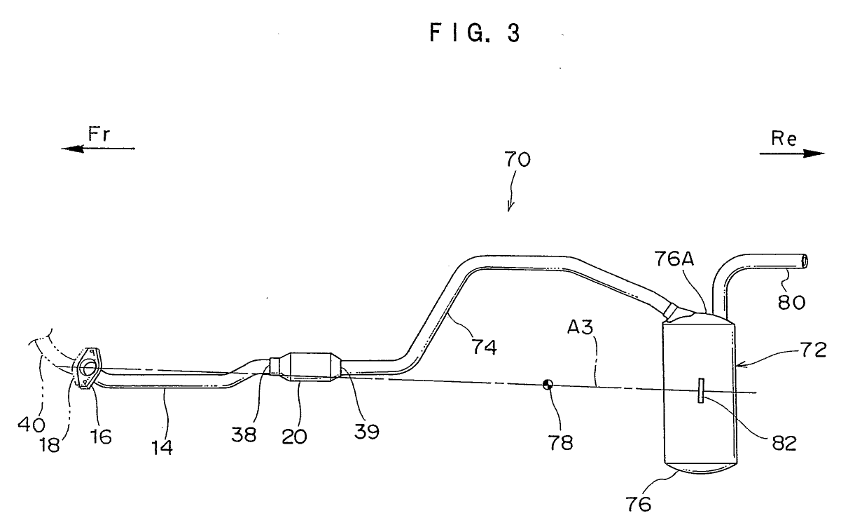

Next, the configuration of an exhaust system disposition structure pertaining to a third embodiment of the invention will be described with reference to FIG. 3.

The exhaust system disposition structure 10 pertaining to the first embodiment of the invention and the exhaust system disposition structure 50 pertaining to the second embodiment of the invention are configured such that the longitudinal direction of the muffler 26 coincides with the vehicle front-rear direction. However, an exhaust system disposition structure 70 pertaining to the third embodiment of the invention is configured such that the longitudinal direction of a muffler 76 is perpendicular to the vehicle front-rear direction (i.e., is in the lateral direction of the vehicle).

In other words, the muffler 76 is disposed on a second exhaust pipe 74 disposed rearward (Re side) of the catalyst 20 such that the longitudinal direction of the muffler 76 is perpendicular to the vehicle front-rear direction.

Further, a tailpipe 80 that extends first in the lateral direction of the vehicle and then rearward is disposed on the rear side (Re side) of a side surface 76A of the muffler 76.

A hanger-like support member 82 is disposed on a center portion of the muffler 76. Additionally, in the exhaust system disposition structure 70 pertaining to the third embodiment of the invention, an exhaust system 72 from the coupling member 16 to the tailpipe 80 end is supported at only one place on an unillustrated vehicle body by the support member 82.

Further, in the exhaust system disposition structure 70, the position of the support member 82 is set such that a center of gravity 78 of the exhaust system 72 is disposed on a straight line A3 joining in plan view the support member 82 that supports the exhaust system 72 on the vehicle body and the coupling member 16.

In the present embodiment, the straight line A3 is the principal axis of inertia of the exhaust system 72. Here, the principal axis of inertia is a hypothetical axis that extends along the longitudinal direction of the exhaust system 72 when the exhaust system disposition structure 70 is seen in plan view, and refers to an axis in which there is little torsional vibration displacement as an axis of torsional vibration in the exhaust system 72.

In the exhaust system disposition structure 70 pertaining to the third embodiment of the invention, the same reference numerals are used for members that are the same as those in the exhaust system disposition structure 10 pertaining to the first embodiment and in the exhaust system disposition structure 50 pertaining to the second embodiment, and description thereof will be omitted.

Next, the action of the exhaust system disposition structure pertaining to the third embodiment of the invention will be described.

According to the exhaust system disposition structure 70 pertaining to the third embodiment of the invention, the exhaust system 72 from the coupling member 60 to the tailpipe 80 end is supported on the unillustrated vehicle body at only the one place of the support member 82. For this reason, the position of the entire exhaust system 72 can be adjusted (aligned) at the one place of the support member 82.

Thus, the position of the entire exhaust system 72 can be easily adjusted in comparison to a configuration where the exhaust system is supported on the vehicle body by plural support members as has conventionally been the case.

Further, in the exhaust system disposition structure 70 pertaining to the third embodiment of the invention, the center of gravity 78 of the exhaust system 72 is disposed on the straight line A3 joining in plan view the support member 82 and the coupling member 16.

Consequently, even if torsional vibration centered on the straight line A3 joining in plan view the support member 82 and the coupling member 16 arises in the entire exhaust system 72 due to the running of the vehicle or the like, there is little torsional vibration displacement (movement in the left-right direction) on the straight line A3 on which the support member 82 is positioned. For this reason, the torsional moment acting on the support member 82 can be kept low.

Thus, because the load acting on the support member 82 is reduced, it is not necessary to apply a special design for raising strength to the support member 82 even when the exhaust system 72 from the coupling member 16 to the tailpipe 80 end is supported on the vehicle body by the one support member 82.

Moreover, in the exhaust system disposition structure 70 pertaining to the third embodiment of the invention, the position of the center of gravity 78 of the exhaust system 72 is maintained on the straight line A3 joining in plan view the support member 82 and the coupling member 16, even if the position of the support member 82 is moved to adjust the position of the entire exhaust system 72.

Consequently, the torsional moment in the left-right direction acting on the support member 82 does not become biased even when the position of the entire exhaust system 72 is adjusted. For this reason, it is not necessary to carry out reinforcement corresponding to bias of the torsional moment in the left-right direction acting on the support member 82 each time the position of the exhaust system 72 is adjusted.

It will be noted that the action and effects of the exhaust system disposition structure 70 pertaining to the third embodiment of the invention that result from the same configuration as that of the exhaust system disposition structure 10 pertaining to the first embodiment and the exhaust system disposition structure 50 pertaining to the second embodiment may be understood by referring to the first embodiment and the second embodiment, and description thereof will be omitted here.

Next, a modification of the exhaust system disposition structure pertaining to the third embodiment of the invention will be described.

In the third embodiment of the invention, the center of gravity 78 of the exhaust system 72 is disposed on the straight line A3. However, the center of gravity 78 of the exhaust system 72 may also be disposed in the vicinity of the straight line A3.

1. An exhaust system disposition structure for disposing an exhaust system which includes a tailpipe and a coupling member that couples the exhaust system to an exhaust manifold, with the exhaust system being disposed on a vehicle body from the coupling member to an end of the tailpipe, the structure comprising:
a single support member that supports, on the vehicle body, the exhaust system from the coupling member to the tailpipe end, at one position which is further toward the tailpipe end than a position which is a center of gravity of the exhaust system from the coupling member to the tailpipe end, and which is at a principal axis of inertia of the exhaust system.

2. The exhaust system disposition structure of claim 1, wherein the center of gravity of the exhaust system is disposed at a position substantially one half of the length of the exhaust system in a vehicle front-rear direction.

3. The exhaust system disposition structure of claim 1, wherein the exhaust system further includes a muffler disposed such that the position of a vehicle front side portion of the muffler is at a position substantially one half of the length of the exhaust system in a vehicle front-rear direction.

4. The exhaust system disposition structure of claim 1, wherein the exhaust system further includes a muffler and a catalyst, and
the catalyst is disposed at a position substantially one half of the length in a vehicle front-rear direction between the coupling member and a vehicle front side portion of the muffler, or substantially one half of the length in a vehicle front-rear direction between the coupling member and the center of gravity of the exhaust system.

5. The exhaust system disposition structure of claim 1, wherein the exhaust system further includes a muffler and a vibration isolating mechanism, the vibration isolating mechanism is disposed further toward the tailpipe end than the coupling member, and
the muffler and the support member are disposed further toward the tailpipe end than the vibration isolating mechanism.

6. The exhaust system disposition structure of claim 1, wherein the exhaust system further includes a catalyst and vibration isolating mechanisms, and
the vibration isolating mechanisms are disposed at the coupling member and at a position rearward of the catalyst.

7. An exhaust system disposition structure for disposing an exhaust system which includes a tailpipe and a coupling member that couples the exhaust system to an exhaust manifold, with the exhaust system being disposed on a vehicle body from the coupling member to an end of the tailpipe, the structure comprising:
a single support member that supports, on the vehicle body, the exhaust system from the coupling member to the tailpipe end at one position which is further toward the tailpipe end than a position which is a center of gravity of the exhaust system from the coupling member to the tailpipe end,
wherein the center of gravity of the exhaust system is disposed at a straight line joining in plan view the coupling member and the support member.

8. The exhaust system disposition structure of claim 7, wherein the center of gravity of the exhaust system is disposed at a position substantially one half of the length of the exhaust system in a vehicle front-rear direction.

9. The exhaust system disposition structure of claim 7, wherein the exhaust system further includes a muffler disposed such that the position of a vehicle front side portion of the muffler is at a position substantially one half of the length of the exhaust system in a vehicle front-rear direction.

10. The exhaust system disposition structure of claim 7, wherein the exhaust system further includes a muffler and a catalyst, and
the catalyst is disposed at a position substantially one half of the length in a vehicle front-rear direction between the coupling member and a vehicle front side portion of the muffler of the exhaust system, or substantially one half of the length in a vehicle front-rear direction between the coupling member and the center of gravity of the exhaust system.

11. The exhaust system disposition structure of claim 7, wherein the exhaust system further includes a muffler and a vibration isolating mechanism, the vibration isolating mechanism is disposed further toward the tailpipe end than the coupling member, and
the muffler and the support member are disposed further toward the tailpipe end than the vibration isolating mechanism.

12. The exhaust system disposition structure of claim 7, wherein the exhaust system further includes a catalyst and vibration isolating mechanisms, and
the vibration isolating mechanisms are disposed at the coupling member and at a position rearward of the catalyst of the exhaust system.
